(19) United States
(12) Patent Application Publication
(10) Pub. No.: US 2019/0178384 A1
(43) Pub. Date: Jun. 13, 2019

(54) PRESSURE-SENSITIVE, FRICTIONLESS SEAL RING DESIGN

(71) Applicant: Carl Freudenberg KG, Weinheim (DE)

(72) Inventor: Marc-Christian Voehringer, Albbruck (DE)

(21) Appl. No.: 16/118,462

(22) Filed: Aug. 31, 2018

(30) Foreign Application Priority Data
Dec. 12, 2017 (DE) 10 2017 011 438.2

(51) Int. Cl. F16J 15/3232; F16J 15/3268

(52) U.S. Cl. CPC F16J 15/3232; F16J 15/3268

(57) ABSTRACT

A seal arrangement includes: a housing; a machine element; a groove, which is placed in the housing or machine element; and a seal ring having a first seal lip for sealing a sealing gap between the housing and the machine element. The seal ring is installed in the groove in a floating manner. The seal ring has at least one additional seal lip. The at least one additional seal lip is arranged as a lateral seal lip in a side surface of the seal ring and contacts lateral groove surfaces.

### CROSS-REFERENCE TO PRIOR APPLICATION

Priority is claimed to German Patent Application No. DE 10 2017 011 438.2, filed on Dec. 12, 2017, the entire disclosure of which is hereby incorporated by reference herein.

### FIELD

The invention relates to a seal arrangement as well as the use of such a seal arrangement in an actuator.

### BACKGROUND

It is known from prior art to install O-rings as piston seals in a floating manner, e.g., in air pumps. When installed in a floating manner, the O-ring is not compacted but only slightly compressed, wherein its inner diameter does not rest against the groove bottom. The advantage of the floating installation of O-rings lies in the free movement and in the low wear of the O-ring under dynamic loads.

As an example of an actuator, AT 009827 U1 is mentioned, in which an actuation device with a cylinder-piston device is described, which briefly moves a piston at very high speed by means of compressed gas. Such an actuation device, which may be designed as a pyrotechnic actuator, is used for example to actuate safety devices in motorized vehicles. An example of such use is described in AT 511710 B1, from which emerges an apparatus for employing an engine hood, which is used for pedestrian protection.

The disadvantage of known piston-and-rod seals using the floating installation of O-rings is that for pistons at rest, moisture or contamination can get past the sealing point. This is due to the O-ring being insufficiently pressed in the groove. When pistons or rods are moved, O-rings tend primarily to twist locally or over the entire circumference due to the friction with the O-ring. Excessive leakage can result from this when a piston or rod moves.

### SUMMARY

In an embodiment, the present invention a seal arrangement comprising: a housing; a machine element; a groove, which is placed in the housing or machine element; and a seal ring having a first seal lip configured to seal a sealing gap between the housing and the machine element, the seal ring being installed in the groove in a floating manner, wherein the seal ring has at least one additional seal lip, and wherein at least one additional seal lip is arranged as a lateral seal lip in a side surface of the seal ring and contacts lateral groove surfaces.

### BRIEF DESCRIPTION OF THE DRAWINGS

The present invention will be described in even greater detail below based on the exemplary figures. The invention is not limited to the exemplary embodiments. Other features and advantages of various embodiments of the present invention will become apparent by reading the following detailed description with reference to the attached drawings which illustrate the following:

FIG. 1 a seal arrangement without pressure applied in a construction as a rod seal

FIG. 2 the contact stress distribution of the three seal lips given a seal arrangement according to FIG. 1 of the seal arrangement without pressure applied

FIG. 3 the seal arrangement from FIG. 1 when pressure is applied

FIG. 4 the contact stress distribution of the seal arrangement according to FIG. 3 when pressure is applied

FIG. 5 a seal arrangement without pressure applied in a construction as a piston seal

FIG. 6 a seal arrangement as a rod seal without pressure applied with a small seal lip radius

FIG. 7 a seal arrangement as a rod seal without pressure applied with a large seal lip radius

FIG. 8 a seal arrangement as a rod seal with pressure applied with a conical groove and a conical cross-section of the seal ring

FIG. 9 a seal arrangement as a rod seal without pressure applied with a seal ring having a rectangular cross-section and a tapering groove width

FIG. 10 a seal arrangement as a rod seal without pressure applied with spacers

FIG. 11 a seal arrangement as a rod seal without pressure applied with lateral lead-in bevels

FIG. 12 a seal arrangement as a rod seal without pressure applied with long lateral seal lips

FIG. 13 a seal arrangement as a rod seal without pressure applied with lateral lead-in bevels

FIG. 14 a seal arrangement as a rod seal without pressure applied with an x-shaped seal ring

FIG. 15 a seal arrangement as a rod seal without pressure applied with two initial seal lips

FIG. 16 a seal arrangement as a rod seal without pressure applied with four additional seal lips

FIG. 17 a seal arrangement as a rod seal without pressure applied with retaining collars

FIG. 18 a seal arrangement as a rod seal with pressure applied with retaining collars

FIG. 19 a seal arrangement as a rod seal without pressure applied with only one additional seal lip

FIG. 20 a seal arrangement as a rod seal with pressure applied with a through-passage to the groove bottom

### DETAILED DESCRIPTION

In an embodiment, the present invention provides a seal arrangement, which in a non-moved state reliably keeps away moisture and contamination, and simultaneously has only minimal friction when pressure is applied and the seal arrangement thus moves. An additional object of the invention is to create a seal arrangement, which is easy to install and has a simple structure.

The seal arrangement according to the invention has a housing which is designed as an outer part, as well as a machine element, particularly a piston or a rod able to move in relation to it, which is designed as an inner part. In the housing or machine element, there is placed a groove for holding a seal ring. The seal ring has a first seal lip for sealing a sealing gap between the housing and the machine element and is installed in a floating manner, i.e., the seal ring does not lie on the groove bottom, or in other words: the cross-sectional thickness of the seal ring is smaller than the seal surface clearance, i.e., the distance between the groove bottom and the rod or between the groove bottom and the housing.

According to the invention, the seal ring has at least one additional seal lip, wherein the seal ring may have in particular two additional seal lips or four seal lips. The at least one additional seal lip is arranged as a lateral seal lip in a side surface of the seal ring and contacts the associated lateral groove surfaces, i.e., the side surfaces of the groove. The lateral groove surfaces can also be referred to as groove end surfaces. The seal arrangement is configured according to the invention in such a manner that the contact stress in the region of the first seal lip is always less than the contact stress in the region of the at least one other seal lip, regardless of whether the seal arrangement is subjected to pressure. By retaining the floating installation of the seal ring, it is advantageously ensured that when pressure is applied and if a certain pressure of the seal arrangement is exceeded, the seal ring is moved into the groove and the relative motion between the housing and machine element can occur without frictional influences of the seal arrangement. By providing at least one additional seal lip, the seal ring is axially pressed into the groove during installation and at the contact surface of the at least one additional seal lip with the at lateral groove surface, a barrier is created, which does not let moisture and contamination pass through when the seal arrangement is at rest.

In an advantageous further development of the seal arrangement according to the invention, lead-in bevels are provided on the seal ring. According to a first variant, the lead-in bevels may be arranged only at the transition from the side surfaces to the groove bottom-side surface. According to a second variant, the lead-in bevels extend over most of the side surfaces. In the third variant, the lead-in bevels extend over all the side surfaces of the seal ring so that a wedge-shaped or trapezoidal design of the seal ring results. All three variants ensure simplified installation of the seal ring.

In another design variant of the seal arrangement considered to be advantageous, the groove is designed conically and the seal ring has a conical cross-section. In an alternative construction variant, the groove has a groove width that tapers toward the groove bottom and the seal ring has a rectangular cross-section. Both design variants have the advantage that the seal ring first moves into the groove when a higher pressure is applied.

In an advantageous manner, this is also achieved by a seal arrangement in another variant, according to which the seal ring has on its side facing the groove bottom at least one projection as a spacer. In particular, two spacers may be provided to achieve symmetrical force distribution.

In a particularly advantageous and thus preferred further development of the seal arrangement according to the invention, the at least one additional seal lip is arranged on the slot-side end of the side surfaces of the seal ring. When there are multiple seal lips per side surface, one seal lip each is arranged at least on the respective slot-side end of the side surface.

It was recognized that the seal ring may also be designed in an x-shaped manner, i.e., it can have an x-shaped cross-section. Improved installation and a reproducible deformation behavior can thereby be achieved.

In an advantageous further development of the seal arrangement according to the invention, the lateral groove surfaces are each provided with an undercut and the side surfaces of the seal ring are each provided with a complementary projection, to form a retaining collar each. By providing such retaining collars, it is advantageously achieved that after pressure has been applied and after the seal ring has moved into the groove, it can no longer move in the sealing gap. The reason is that when using the seal arrangement in an actuator, the pressure can slowly escape out of the actuator. If the actuator is used for example as a pyrotechnic actuator to raise the engine hood of a motorized vehicle for pedestrian protection, an achievement is that the engine hood is lowered again after a defined period of time.

In an advantageous further development of the seal arrangement according to the invention, the region of the groove bottom of the groove is connected by means of at least one narrow through-passage, e.g., a bore hole, to a pressure chamber to generate a time-delayed pressure in the region of the groove bottom when pressure is applied. In other words, one or more small bore holes are made in the groove bottom, i.e., in the groove toward the pressure chamber. If designed as a piston seal, a time-delayed pressing of the seal ring to the piston is thereby achieved so that the leakage is minimal when the piston is extended and after the piston is extended, the seal ring is pressed back against the piston. If designed as a rod seal, a time-delayed pressing of the seal ring to the rod is achieved so that leakage is minimal when the rod is extended and after the rod is extended, the seal ring is pressed against the rod again. Holding the pressure when the actuator is extended is important so that a component to be moved by the actuator, e.g., an engine hood, does not drop again immediately after the actuator is extended.

In a first embodiment of the seal arrangement, the groove is arranged in the housing and the seal arrangement is designed as a rod seal. By contrast in a second embodiment of the seal arrangement, the groove is arranged in the machine element and the seal arrangement is designed as a piston seal.

The invention also relates to the use of a seal arrangement as described above in an actuator, particularly in a very fast-acting actuator, such as a pyrotechnic actuator for example, wherein when the actuator is subjected to pressure the seal ring plunges deeper into the groove. The contact pressure of the seal ring is thereby less than the pressure in the chamber to be sealed when the operating pressure is greater in relation to the ambient pressure.

The described invention and the described advantageous further developments of the invention also represent advantageous further developments when combined with each other—to the extent it is technically reasonable.

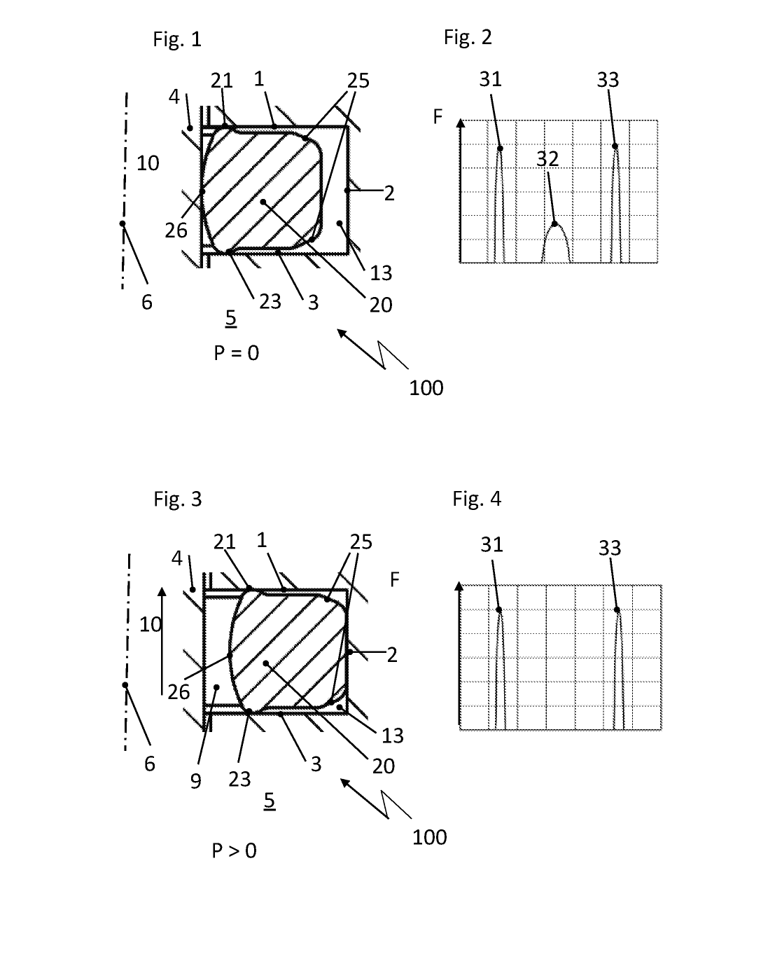

FIGS. 1 and 2 depict a seal arrangement 100, with a housing 5 and a machine element moveable in relation to it, designed as piston 4. Dashed-dotted line 6 indicates the center line and axis of symmetry of seal arrangement 100. A groove 13 is made in housing 5. Groove 13 has a groove end surface facing away from pressure as groove side 1, a groove bottom 2 and a pressure-facing groove end surface as groove side 3. A seal ring 20 is inserted in groove 13. Seal ring 20 is installed in a floating manner in groove 13, i.e., groove ring 20 has no contact with groove bottom 2. This is the condition of seal arrangement 100 when there is only ambient pressure and thus P=0. Seal ring 20 is constructed in such a manner that it has a seal lip 26 in the seal region between the machine element and the housing, in other words here between piston 4 and housing 5, said seal lip contacting piston 4. In addition, seal ring 20 has a first additional lateral seal lip 21, specifically on the side, facing away from pressure, of seal ring 20 near the contact surface of seal lip 26 and a second additional lateral seal 23, which is arranged on the pressure-facing side of seal ring 20 also near the contact surface of seal lip 26. These two additional lateral seal lips 21, 23 contact lateral groove surfaces 1 and 3 respectively and represent a barrier to moisture and contamination, so that these cannot get past seal arrangement 100.

If seal arrangement 100 is subject to a pressure 9 that is above atmospheric pressure and if a certain pressure is exceeded, seal ring 20 is pressed into groove 13. As one can see in FIG. 3, seal ring 20 is pushed so far into groove 13 until seal ring 20 lies on groove bottom 2. Then a motion 10 of piston 4 is possible without seal ring 20 having a frictional influence.

Seal ring 20 moves in groove 13 or detaches from the piston or rod 4 when a certain pressure P_x is reached. Certain pressure P_x may be 7 bar, for example. Seal ring 20 then first detaches at P>P_x from the piston or rod 4 and not at a lower pressure P.

Required pressure P_x to move seal ring 20 thereby depends on the following parameters:

the friction coefficient and the surface size between seal ring 20 and the two lateral groove end surfaces

the axial pressing height

the hardness of the seal

the groove shape or the angle of the two front surfaces (groove tapering).

For a conical groove shape, the necessary pressure P is larger primarily due to the incompressibility of the material

the presence of spacer nubs 12 as depicted in FIG. 10 and the design of spacer nubs 12

the construction variant of seal arrangement 100, i.e., as a rod or piston seal. For example, for a rod seal, seal ring 20 is expanded, wherein low pressure is needed. For a piston seal, seal ring 20 is compressed, wherein a higher pressure is needed.

For easier installation, seal ring 20 may be provided with lead-in bevels 25 as one can see in FIGS. 1 and 2.

In the depicted embodiment, seal ring 20 is dimensioned in such a manner that an axial compression of seal ring 20 in groove 13 occurs. FIG. 2 depicts the contact stress of the seal lips for the seal arrangement according to FIG. 1, i.e., without pressure applied at P=0. Contact stress 31 of lateral seal lip 21 facing away from pressure as well as contact stress 33 of pressure-facing lateral seal lip 23 are greater than contact stress 32 of the first seal lip on the piston or rod 4.

If a pressure P>0 is applied to seal arrangement 100, seal ring 20 will then move into groove 13, as depicted in FIG. 3. As one can see in FIG. 4, there is no contact stress 32 any more of the first seal lip on the piston or the rod. However, contact stresses 31, 32 of lateral seal lips 21, 23 are maintained.

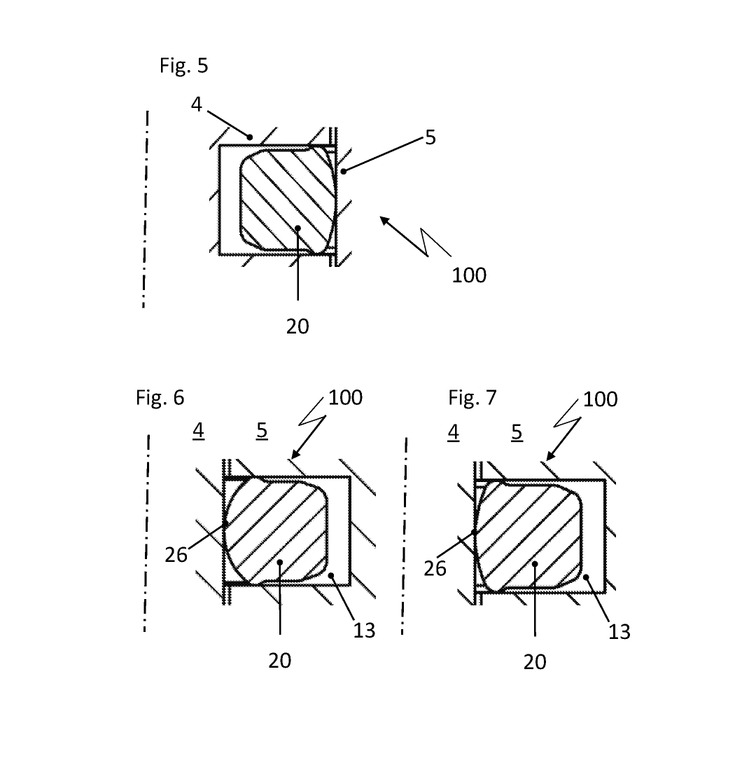

While FIGS. 1 and 3 as well as the other drawings depicting seal arrangements 100 each portray a rod seal, FIG. 5 shows a piston seal. Seal arrangement 100 has a housing 5, a piston 4 that can move relative to it, and a seal ring 20. Piston 4 has a groove 13, in which seal ring 20 is located.

FIGS. 6 and 7 depict seal arrangements 100, which have a seal ring 20 with various radii R of first seal lip 26. According to FIG. 6, seal lip radius R of first seal lip 26 is significantly smaller than seal lip radius R according to FIG. 7.

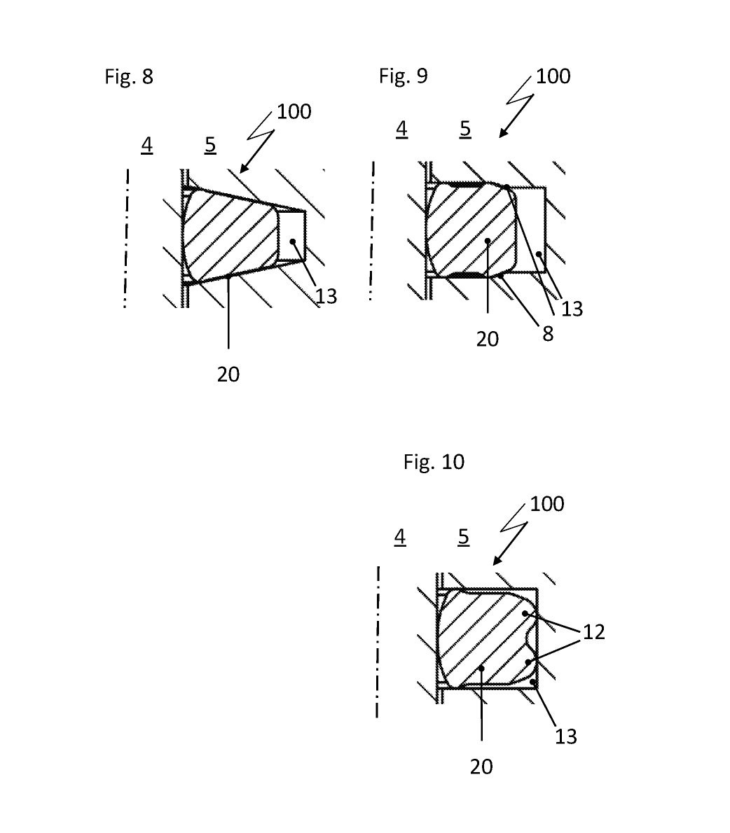

FIGS. 8 to 10 described below show seal arrangements in which seal ring 20 first moves into groove 13 at a higher applied pressure P.

According to FIG. 8, seal ring 20 has a conical cross-section and groove 13 is also constructed in a conical manner.

According to FIG. 9, seal ring 20 has an essentially rectangular cross-section, while the groove width of groove 13 tapers over a non-continuous bevel 8.

In the variant according to FIG. 10, seal ring 20 is constructed with two spacers arranged on the side of the groove bottom, as spacer nubs 12. Spacer nubs 12 result in seal ring 20 not lying in a planar manner on groove bottom 2 when no pressure is applied. When a pressure P>0 is applied, a groove bottom-side deformation of seal 20 is possible so that seal ring 20 can plunge deeper into groove 13. A corresponding construction of spacer nubs 12 enables one to set a pressure P at which seal ring 20 plunges into groove 13.

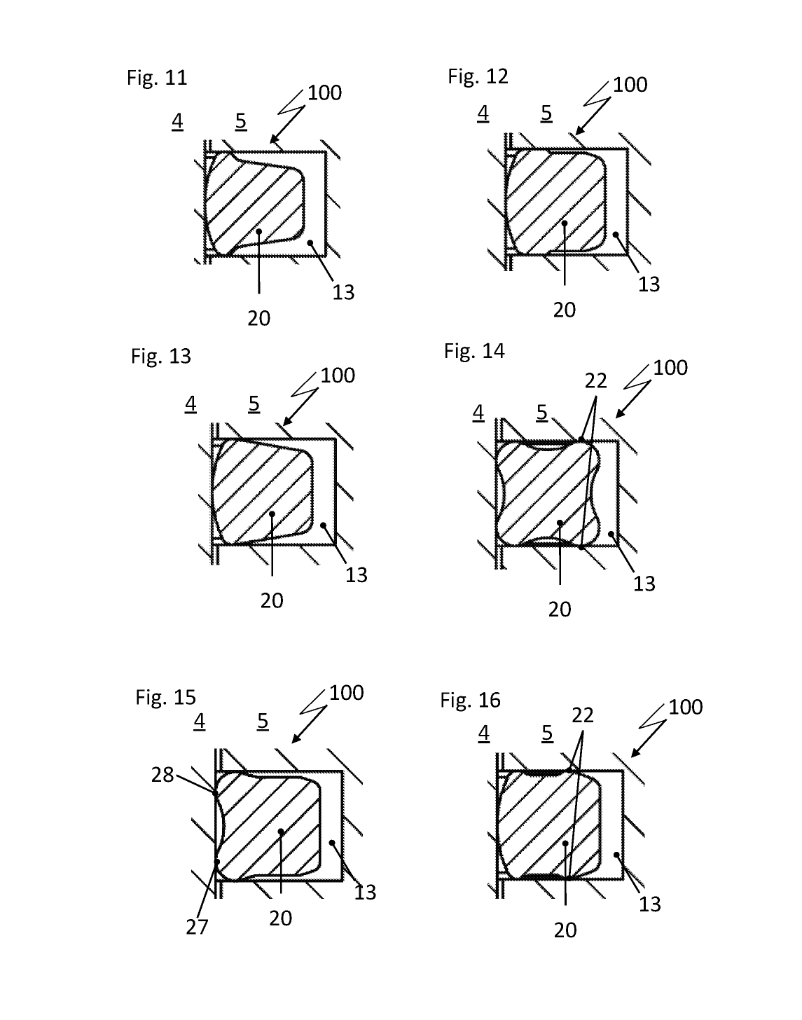

In the construction variants of seal arrangement 100 described below and depicted in FIGS. 11 to 13, possible designs of seal ring 20 are shown which allow better and simpler installation as well as a reproducible deformation behavior of seal ring 20.

In the variant according to FIG. 11, seal ring 20 has a lead-in bevel 25 which extends over most of the side surface of seal ring 20.

In the variant according to FIG. 13, lead-in bevel 25 extends in each case over the entire side surface of seal ring 20.

In the variant according to FIG. 12, seal ring 20 has particularly wide additional lateral seal lips 21, 23. As a result, the risk of tilting of seal ring 20 is decreased.

In the variant according to FIG. 14, a seal ring 20 having an x-shaped cross-section is used. This seal ring 20 has two groove bottom-side lateral support lips 22 in addition to lateral seal lips 21, 23.

In the variant according to FIG. 15, seal lip 26 of seal ring 20 is designed in a two-part manner by a first pressure-facing seal lip 27 to the piston or rod, and by a second seal lip 28, facing away from pressure, to the piston or rod.

In the variant of seal ring 20 depicted in FIG. 16, said seal ring has an essentially rectangular cross-section and lateral support lips 22 in addition to lateral seal lips 21, 23. This construction variant can also prevent a tilting motion of seal ring 20.

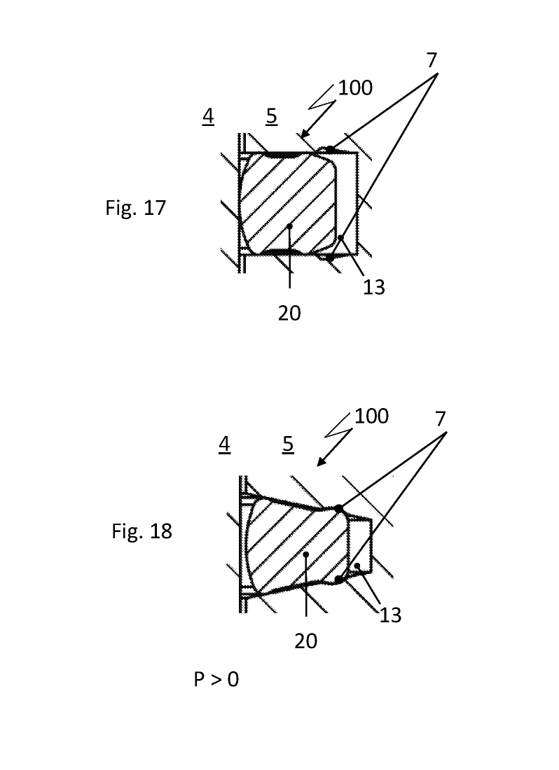

In the variants of seal arrangement 100 shown in FIGS. 17 and 18, a construction is selected in which, after pressure is applied, seal ring 20 remains in groove 13 and no longer moves back into the sealing gap. While FIG. 17 shows a rectangular configuration of seal ring 20 and groove 13, FIG. 18 reveals a conical construction of seal ring 20 and groove 13. In both cases, lateral groove undercuts 7 are provided, which function as retaining collars. The situation is depicted in FIG. 17, with seal arrangement 100 not yet subjected to pressure. FIG. 18 shows that after pressure P>0 is applied, seal ring 20 plunges into groove 13, is retained there by retaining collars in groove undercuts 7, and can no longer move back.

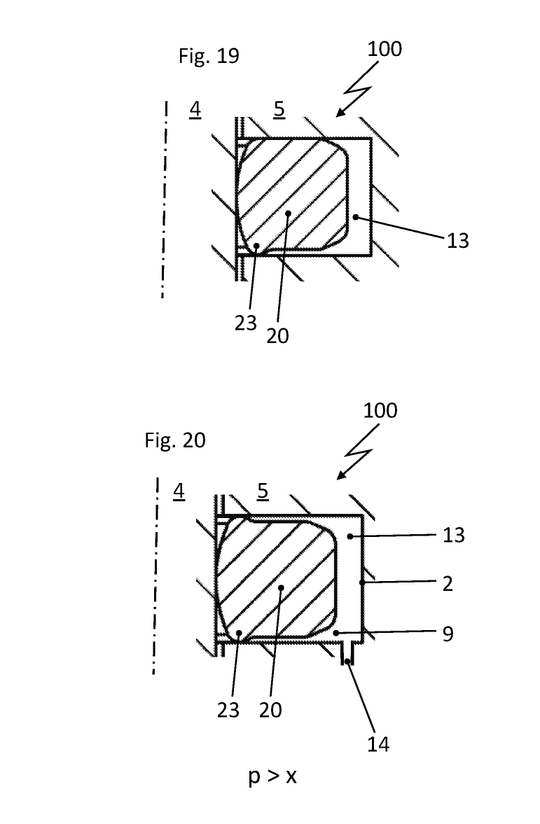

FIG. 19 shows an alternative embodiment of seal arrangement 100. Contrary to the previously described seal arrangements 100 depicted in the other drawings, according to FIG. 19 seal ring 20 has only a lateral seal lip 23 on the pressure-facing side of seal ring 20, which is also arranged near the contact surface of first seal lip 26.

FIG. 20 depicts an additional embodiment of seal arrangement 100, in which, after pressure is applied, seal ring 20 is displaced into groove 13 and moves back into the sealing gap. To do so, a narrow through-passage 14 is provided, which connects groove bottom 2 of groove 13 to a pressure chamber, where there is a pressure p>0. This is used to generate a time-delayed pressure 9 in the region of groove bottom 2 when pressure is applied.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

1 Groove side (groove end surface facing away from pressure)
2 Groove bottom
3 Groove side (pressure-facing groove end surface)
4 Piston or rod
5 Housing
6 Center line and axis of symmetry
7 Lateral groove undercut
8 Groove bevel
9 Pressure
10 Piston/rod movement direction
11 Plastic shell (concave on one side)
12 Spacer nub
13 Groove
14 Passage
20 Seal ring
21 Lateral seal lip, facing away from pressure, near contact surface
22 Lateral support lip
23 Pressure-facing lateral seal lip near contact surface
25 Lead-in bevel on ring
26 Seal lip to piston/rod
27 Pressure-facing seal lip to piston/rod
28 Seal lip, facing away from pressure, to piston/rod
31 Contact stress of lateral seal lip facing away from pressure
32 Contact stress of first seal lip to piston/rod
33 Contact stress of pressure-facing lateral seal lip
100 Seal arrangement
P Pressure
F Contact stress
R Seal lip radius

What is claimed is:

1. A seal arrangement comprising:
a housing;
a machine element;
a groove, which is placed in the housing or machine element; and
a seal ring having a first seal lip configured to seal a sealing gap between the housing and the machine element, the seal ring being installed in the groove in a floating manner,
wherein the seal ring has at least one additional seal lip, and
wherein at least one additional seal lip is arranged as a lateral seal lip in a side surface of the seal ring and contacts lateral groove surfaces.

2. The seal arrangement according to claim 1, wherein a contact stress in a region of the first seal lip is always less than a contact stress in a region of the at least one additional seal lip.

3. The seal arrangement according to claim 1, further comprising lead-in bevels are provided on the seal ring,
wherein the lead-in bevels are arranged only at a transition of side surfaces to a groove bottom-side surface, or
wherein the lead-in bevels extend over most of the side surfaces, or
wherein the lead-in bevels extend over all the entire side surfaces.

4. The seal arrangement according to claim 1, wherein the groove is constructed conically and the seal ring has a conical cross-section.

5. The seal arrangement according to claim 1, wherein the groove has a groove width that tapers toward a groove bottom and the seal ring has a rectangular cross-section.

6. The seal arrangement according to claim 5, wherein the seal ring has on a side facing the groove bottom at least one projection as a spacer.

7. The seal arrangement according to claim 1, wherein the at least one additional seal lip is arranged on a gap-side end of the side surface of the seal ring.

8. The seal arrangement according to claim 1, wherein the seal ring is x-shaped.

9. The seal arrangement according to claim 1, wherein in each case the lateral groove surfaces are provided with an undercut and the side surfaces of the seal ring are provided with a complementary projection to form a retaining collar in each case.

10. The seal arrangement according to claim 1, wherein a region of a groove bottom of the groove is connected by at least one narrow through-passage to a pressure chamber.

11. The seal arrangement according to claim 1, wherein the groove is arranged in the housing and the seal arrangement comprises a rod seal.

12. The seal arrangement according to claim 1, wherein the groove is arranged in the machine element and the seal arrangement comprises a piston seal.

13. A method of using the seal arrangement according to claim 1 in an actuator, comprising:
subjecting the actuator to pressure so as to plunge the seal ring deeper into the groove.
